(19) United States
(12) Patent Application Publication
(10) Pub. No.: US 2001/0036072 A1
(43) Pub. Date: Nov. 1, 2001

(54) Theater aisle lighting system

(76) Inventor: Paul W. Baker, Eden Prairie, MN (US)

Correspondence Address: Nickolas E. Westman, WESTMAN CHAMPLIN & KELLY, International Centre- Suite 1600, 900 South Second Avenue, Minneapolis, MN, 55402-3319, US

(21) Appl. No.: 09/799,431

(22) Filed: Mar. 5, 2001

Related U.S. Application Data
(60) Provisional application No. 60/187,344, filed on Mar. 6, 2000.

(51) Int. Cl. F21S 8/00

(52) U.S. Cl. 362/146; 362/153; 362/368

(57) ABSTRACT

Extrusions are used for providing lighted transitions between floor portions in theaters, and include integrally molded and hinged covers that overlie channels receiving lighting strips. The extrusions are clear in at least portions to permit light to shine through. The extrusions include caps that go over corners of stairs, to provide a lighted corner for the stairs. The extrusions are formed to have wall portions that will overlie edges of carpeting so that the carpet edges are protected and held in the extrusions.

The present application is based on and claims the benefit of and priority on U.S. Provisional Patent Application Ser. No. 60/187,344, filed Mar. 6, 2000, the content of which is hereby incorporated by reference in its entirety.

### BACKGROUND OF THE INVENTION

The present invention relates to aisle and stair lighting for theaters, in particular, that can be easily extruded or molded from a plastic material, and can be used for holding carpet in place along at least one longitudinal edge, and provide a sloped surface so that it is essentially unlikely to cause tripping. The molding has a hinged cover that is integrally molded in place, and can snap closed. When opened, the cover provides access to chambers on the interior for wiring, lighting, and the like that runs down along the length of the holders.

### SUMMARY OF THE INVENTION

The present invention relates to a molded or extruded plastic holder and support for lighting along aisles and stairs of a theater. The extrusions are made so that they can be supported on floors, and will provide smooth access to raised floor portions. The covers are hingedly mounted integrally with the extrusions, and can be snapped into a closed position or lifted up for access to recesses for fiber optic lights, and, for example, wiring or LED lights.

Two different forms are shown, one for the risers of a step, and the other which extends along the side of an aisle with theater seats on one side and carpeting in the aisle. The length of the extrusions are as needed.

### BRIEF DESCRIPTION OF THE DRAWINGS

FIG. 1 is an end elevational view of a holder and support forming a transition piece between vinyl floor and carpeting adjacent to theater seats;

FIG. 2 is a top plan view of the device of FIG. 1;

FIG. 3 is an end sectional view of a lighting profile extrusion for the edge of a step, where carpet covers the step tread and the riser for the step;

FIG. 4 is a schematic top plan view of the step lighting profile extrusion of FIG. 3;

FIG. 5 is an end sectional view of a typical endcap used with the floor lighting profile extrusions for the edges of steps;

FIG. 6 is a front view of the end portion of the floor lighting profile of FIG. 3 showing the endcap in position; and

FIG. 7 is a plan view of the endcap of FIG. 5 taken on line 7-7 in FIG. 5.

### DETAILED DESCRIPTION OF THE ILLUSTRATIVE EMBODIMENTS

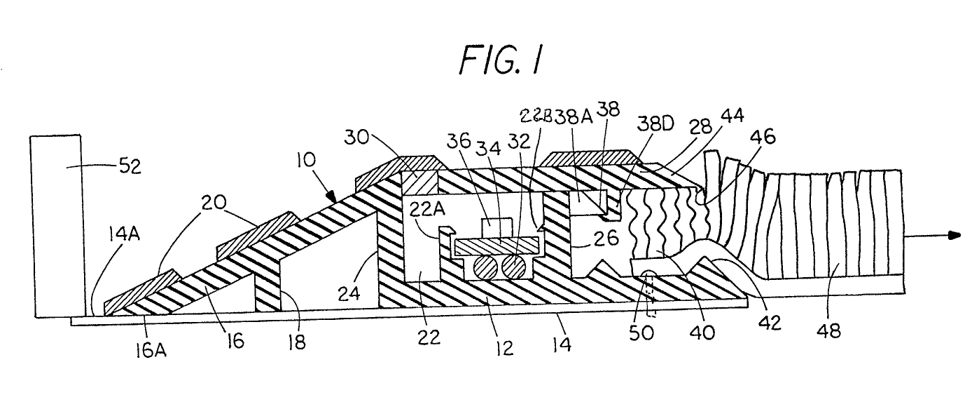

FIG. 1 is an end sectional view of a plastic extrusion used along the sides of theater seats, and an aisle, to create a transition between aisle carpeting and vinyl tile on a floor that is used under theater seats. The transition extrusion indicated generally at 10 has a base wall 12 that lies along a vinyl tile surface 14, and as can be seen, the tile 14 extends as shown at 14A under a tapered wall 16 that is supported at a lower edge surface 16A on the vinyl tile 14. A support leg 18 also supports the tapered wall 16. The tapered wall 16 has a plurality of flexible anti-skid members that extend along the length of the channel on the upper side, and which are indicated at 20. The extrusion 10 includes a channel portion 22 defined by an upright wall 24 adjacent the upper end edge of the tapered wall 16 and supporting the edge of tapered wall 16. The channel portion 22 has an outer upright wall 26. The channel portion or channel 22 is covered with a cover member 28 that is attached to the walls 16 and 24 with a flexible hinge 30 that is extruded in place out of polyvinylchloride, and which will permit the cover to be released from its latched position that is shown in FIG. 1, so that it can hinge upwardly for access to the interior of channel 22. The channel 22 houses electrical wires 32 that are rested below a printed circuit (P.C.) board 34 that carries suitable surface mounted lights of a low light level indicated at 36. A latch wall 22A holds the P.C. board 34 in place along with a projection 22B on wall 26.

The right-hand side of the transition extrusion 10, to the right-hand side of the wall 26, includes the latching members shown at 38 for holding the cover 28 in place. The cover 28 and base wall 12 define a laterally open channel 40 that has carpet retaining ridges or projections 42 on the lower side or base wall. An overhanging lip or member 44 from the cover 28 has a small projection 46 that will tend to hold a carpet shown at 48 in position. Suitable screws 50 are used for fastening the extrusion 10 down onto the floor, and the carpet 48 then extends across an aisle between sets of theater seats. The theater seats are illustrated just schematically with an upright block 52, and the aisle is then to the right of the carpet section 48, the direction of which aisle is illustrated by an arrow.

The latch 38 includes a fixed latch member 38A that mounts onto the wall 26, and a flexible latch dog 38D that can be pried out of the way for lifting the cover 28 about its hinge 30 for access to the interior of the channel 22.

It can be understood that the length of the transition extrusion or piece 10 can be the desired length of the aisle, and if the length is greater than that which can be extruded and handled conveniently, for example, 8 foot sections, the sections can be abutted end to end against each other and held in place with the screws 50.

FIGS. 3 and 4 show a floor lighting profile extrusion indicated generally at 60 which goes over a step 62, that has carpeting 63 on the riser surface 63A of the step 62, and carpeting on the tread of the step, which is shown at 64, that mounts on the tread surface 64A.

The floor lighting profile 60 has a base wall 66 that is extruded, and has an offset wall 68 that receives the carpeting 64 from the tread 64A, and has a overhanging section 70 that includes a depending wall 72 that receives the end of the carpet 63 that lies along the riser surface 63A. The base wall 66 is secured in place with screws 74, that are nested in a small channel, and a small recess channel 76 is formed above the base wall and houses a fiber optic light strip shown at 78 powered from a suitable power source. An overhanging strip or wall 68 is supported on an upright wall 69 formed with base wall 66 and there is a flexible hinge 80 that is molded or extruded in place when the parts are extruded. Hinge 80 hingedly supports a cover 82 that has a latch dog 84 that will fit under a latch surface 86 to latch the cover in place and overlie the fiber optic light strip 78. The overhanging portion 70 is made or extruded to define a channel 88 in which a printed circuit board assembly 90 can be mounted, and the circuit board can carry LEDs 91 or other lights, and can be used then for lighting through a clear polyvinylchloride surface shown at 92 at the forward edge of the step 62 as a warning.

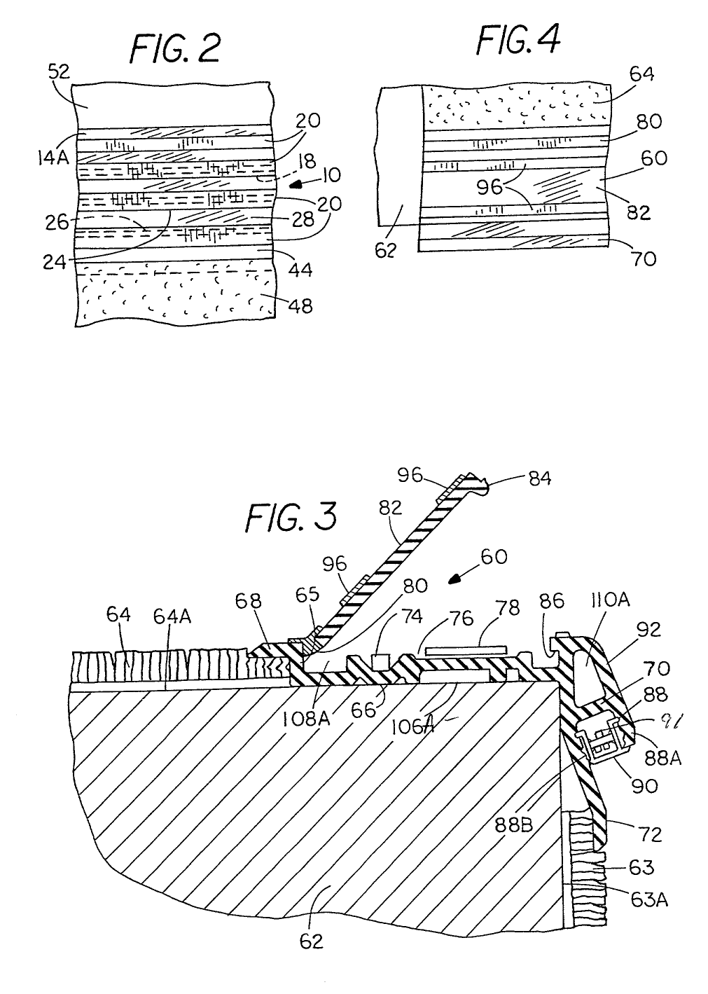

The entire extruded section of the floor lighting profile 60 can be made of clear polyvinylchloride, as can the molding shown in FIGS. 1 and 2, so that lights can be seen through the cover 82 and other portions of the extrusion. Suitable anti-skid pads 96 can be applied to the upper surface in desired locations.

The LEDs 91 can be directed up or down, with suitable retaining clips that fit into the walls 88A of the channel 88, and suitable irregularities or clip type recesses 88B that are on the surface of the wall 72 forming the channel 88.

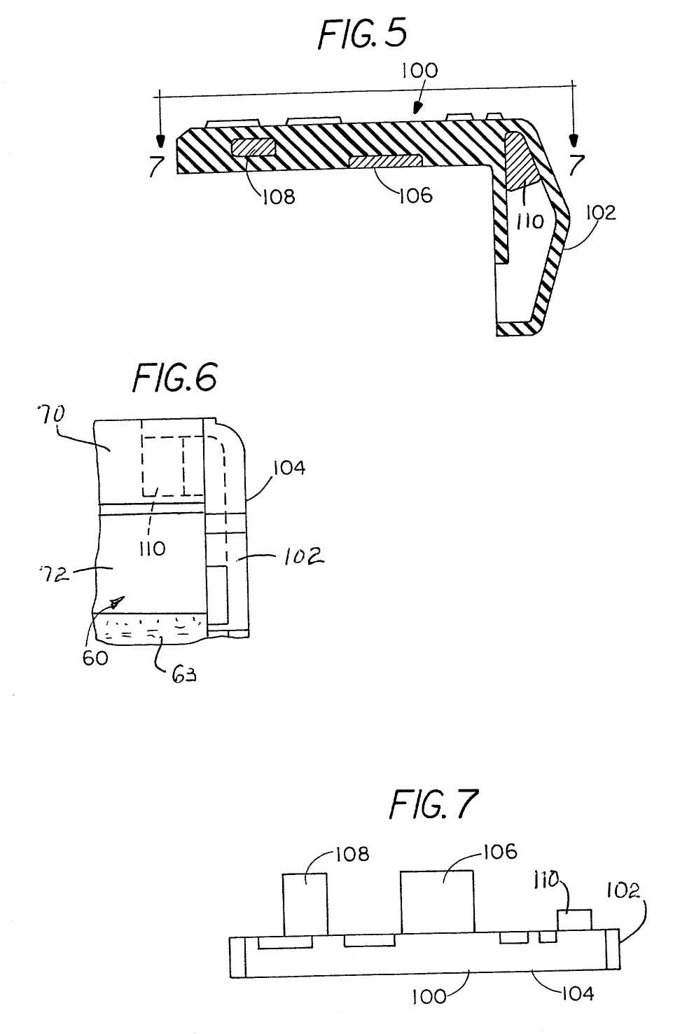

As shown in FIGS. 5, 6 and 7, an endcap 100 can be used for mounting on the ends of the floor profile 60, and has an overhanging wall portion 102 that will close the end of the extrusion or floor profile 60. This is shown schematically in FIG. 6, and will provide a smooth outer surface 104 at the ends or sides of the stairs. Suitable protrusions 106 that fit into extruded slots in the floor profile channel are illustrated, and will slide into place to hold the endcaps on the ends of the floor lighting profile. For example, the protrusion 106 will fit into the recess shown at 106A in FIG. 3, and the extrusion 108 will fit into the recess shown at 108A in FIG. 3. Thus the length of the end cap extends along the end of the tread of the stair.

Additionally, a protrusion 110 is made so that it will fit into the opening or tubular recess shown at 110A in FIG. 3.

The entire assembly can be easily molded or extruded out of polyvinylchloride and can be kept clear for safety lighting in theater environments.

Although the present invention has been described with reference to preferred embodiments, workers skilled in the art will recognize that changes may be made in form and detail without departing from the spirit and scope of the invention.

What is claimed is:

1. An extruded plastic transition member for holding carpeting on at least one edge of the extruded member, comprising a unitary extruded plastic holder, including a cover having an extruded hinge attached to a base portion of the holder, a channel formed in the holder between the base and the cover, the channel being adapted for holding lighting to be visible through the portions of the holder, and a latch for holding the cover in a closed position overlying the channel.

2. The extrusion of claim 1, wherein the holder is formed to have an overhanging lip on one edge for forming a laterally open second channel for receiving carpeting along the length of the holder.

3. The extrusion of claim 1, wherein said plastic is a clear material in portions overlying the channel for holding lighting.

4. The extrusion of claim 1, wherein the holder has a laterally open second channel along one side thereof for receiving carpeting, the second channel being formed by a portion of a base wall of the extrusion, and a portion of the cover.

5. The extrusion of claim 1, wherein the cover forms an upper wall of the holder and is spaced from a support surface of the base, and a tapered wall tapering from the level of the cover to the level of the base support surface along one edge of the holder to provide a transition wall inclined upwardly from the level of the base support surface to the cover.

6. The extrusion of claim 5, wherein said tapered wall is supported on at least one upright wall between the cover and an outer edge of the tapered wall.

7. The extrusion of claim 6, wherein the channel includes surface irregularities for retaining lighting in the channel.

8. The extrusion of claim 1, wherein said base has a first portion for supporting on a first surface, and a second integral portion for resting against a second surface perpendicular to the first surface to form a holder that fits over a corner joining the first and second surfaces.

9. The extrusion of claim 8, wherein said cover is positioned on the first portion of the holder for supporting on the first surface, and wherein the cover terminates along a plane lying along the second surface.

10. The extrusion of claim 8, wherein said first portion has the channel, the channel being adapted for receiving a first lighting member, said first lighting member being covered by said cover, and the second portion of said holder forming a second channel for receiving a second lighting member.

11. A theater aisle lighting system extrusion comprising an extruded transition member having a base wall, an upright wall, a hinge member, and a cover supported by the hinge member to the upright wall, a channel formed in said base wall, the cover extending to overlie the channel when the cover is in a closed position, and a latch for holding the cover in its closed position relying the channel.

12. The theater lighting system of claim 11, wherein said channel has a support for a lighting member extending along the length of the channel.

13. The theater lighting system of claim 11, said latch comprises a molded catch member on the cover, and a surface on the channel for receiving the catch member.

14. The theater lighting system of claim 11, wherein said extruded transition member has a wall member along one edge that is spaced from a support plane for the base wall, said wall member forming a recess for receiving carpeting along the one edge of the extruded transition member.

15. The theater lighting system of claim 14, wherein said recess is formed by a portion of the base extending beneath and spaced from the wall member, and said wall member forming a part of the cover.

16. The theater lighting system of claim 11, and a plurality of anti-skid members on an upper surface of said cover.

17. The theater lighting system of claim 11, wherein said base wall forms a support plane, and a tapered wall extending upwardly to the hinge member from a position spaced from a lateral side of the base wall, a generally upright support wall supporting the tapered wall at a position spaced from the base wall.

18. A corner cap member for use on a stair having a tread surface and a riser surface, comprising an extruded member having a base wall for resting on the tread surface, said base wall having an upright wall along one edge thereof, a hinge member joined to the upright wall, a cover joined to the hinge member and positioned to overlie a portion of the base wall and being spaced therefrom, a support on the base wall and beneath the cover for supporting a lighting member, and the extrusion having a second portion that has a surface for engaging the riser surface of the stair and providing an extruded cover over a corner formed between the riser surface and the tread surface.

19. The corner cap member of claim 18, wherein said second portion has a wall that is spaced from the riser surface a sufficient amount to overlie a portion of a carpet on the riser surface.

20. The corner cap member of claim 19, wherein said second portion includes a second channel for receiving a lighting member, said second channel facing generally in direction along the riser surface.

21. The corner cap member of claim 20, and an end cap for fitting onto the end of the cap member including protrusions that fit into receptacles formed in both the first and second portions of the corner cap member.
